(19) United States
(12) Patent Application Publication
(10) Pub. No.: US 2004/0119204 A1
(43) Pub. Date: Jun. 24, 2004

(54) Process for producing light transmitting plate

(75) Inventor: Yoshiki Nishigaki, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/704,625

(22) Filed: Nov. 12, 2003

(30) Foreign Application Priority Data
Dec. 24, 2002 (JP) 2002-371740

(51) Int. Cl. B29C 45/00

(52) U.S. Cl. 264/328.7; 264/328.16

(57) ABSTRACT

There is provided a process for producing a light transmitting plate comprising the steps of:

(1) connecting a cylinder of an injection unit with a cavity of a mold having a diagonal length of from 14 inches (355 mm) to 30 inches (760 mm), wherein (i) said mold is for making a light transmitting plate for a liquid crystal display, (ii) said mold comprises a fixed mold and a movable mold, and (iii) a cavity side of at least one mold of said fixed mold and said movable mold has a rough pattern on its surface,

(2) supplying a transparent resin to said cylinder, and melting said resin,

(3) filling said resin into said mold cavity from said cylinder at an injection rate of from 1 to 15 cm³/sec per one light transmitting plate, wherein said resin passing through an inlet of said mold has a viscosity of from 50 to 5000 Pa·sec,

(4) pressing additionally said resin present in said mold cavity from a side of said cavity during or after the above-mentioned filling, and

(5) cooling said resin under holding said pressure to solidify said resin, thereby obtaining a light transmitting plate having said rough pattern on its surface.

### FIELD OF THE INVENTION

The present invention relates to a process for producing a light transmitting plate used as a back light unit of a liquid crystal display. More specifically, the present invention relates to a process for producing a large-sized light transmitting plate having a diagonal length of from 14 inches (355 mm) to 30 inches (760 mm).

### BACKGROUND OF THE INVENTION

A light transmitting plate is used as an optical element for transmitting light from a light source arranged on a lateral side to a liquid crystal displaying face in a liquid crystal display of a product such as a notebook-type personal computer, a desk-top personal computer and a liquid crystal display-carrying television set. FIG. 1 is a schematic sectional drawing, which shows an arrangement of a liquid crystal display and a light transmitting plate. A back light unit arranged in the rear side of a liquid crystal display 1 is composed mainly of a light transmitting plate 2 or 3, a reflection layer 4 placed in the rear side thereof, a light diffusion layer 5 facing the light transmitting plate 2 or 3 (facing the liquid crystal display), a light source 7 placed on the lateral side(s) of the light transmitting plate 2 or 3, and a reflector 8 for transmitting light from the light source 7 into the light transmitting plate 2 or 3. The light from the light source 7 is reflected by the reflector 8 to enter into the light transmitting plate 2 or 3, and, while passing through the light transmitting plate 2 or 3, is reflected by the reflection layer 4, and then is emitted out of the front side. On the front side of the plate, light is emitted uniformly from the whole area due to the presence of the light diffusion layer 5, and serves as illumination for the liquid crystal display 1. A cold cathode-ray tube is generally used as the light source 7. It is also known to use a prism sheet as the light diffusion layer. A pattern such as a dot and a line is printed, if necessary, on the rear side of the a light transmitting plate 2 or 3 so that light is emitted uniformly out of the front side.

FIG. 1(a) shows an arrangement used for a relatively small-sized display having a diagonal length of not longer than about 14 inches for a product such as a notebook-type personal computer, and its light transmitting plate 2 has a wedge-like shape, whose thickness gradually increases from about 0.6 mm to about 3.5 mm. When using such a wedge-like shaped light transmitting plate 2, the light source 7 is generally placed at the thicker end thereof. Although FIG. 1(a) shows an example having one light source 7, plural light sources may be used. On the other hand, FIG. 1(b) shows an arrangement used for a larger-sized display in a product such as a desk-top personal computer and a liquid crystal display-carrying television set, and its light transmitting plate 3 has a sheet-like form, whose thickness is almost uniform. When using such a sheet-like shaped light transmitting plate 3, the two light sources 7 are generally placed on two opposed lateral sides, respectively. Although FIG. 1(b) shows an example, wherein each of two light sources 7 is placed on each of the lateral sides, plural light sources such as two light sources and three light sources may be arranged on each lateral side for a larger display.

Such a light transmitting plate 2 or 3 is made of a methacrylic resin having a superior light transmittance. A wedge-like shaped light transmitting plate 2 as shown in FIG. 1(a) is produced according to an injection molding method, and a sheet-like shaped light transmitting plate 3 as shown in FIG. 1(b) is produced according to a method of cutting out from a resin sheet. In case of producing according to the former method, an attempt has been made to produce a light transmitting plate without printing, wherein a light transmitting plate having on its surface a pattern such as a dot and a line is produced using a mold having said pattern on its surface, said pattern being a pattern of a reflection layer. A further attempt has been made to eliminate a diffusion plate or a prism sheet, wherein a pattern having a light diffusion capability or a light orientation capability is formed by applying said technique to a light emission surface as well.

As a process for producing a light transmitting plate according to an injection molding method, there is known a process disclosed in JP 2002-46259 A.

### SUMMARY OF THE INVENTION

However, said process disclosed therein has problems that (1) a rough pattern present on a cavity surface cannot be copied satisfactorily on a light transmitting plate, and (2) a molding cycle time is unsatisfactorily too long. In the present invention, the term “copy” as used above means “transfer”.

An object of the present invention is to provide a process for producing a light transmitting plate not having the above-mentioned problems. A light transmitting plate obtained by a process in accordance with the present invention is also superior in its thickness accuracy, dimensional stability and transparency.

The present inventor has undertaken extensive studies to develop a process for producing a light transmitting plate (particularly, a large-sized light transmitting plate), and, as a result, has found that the above-mentioned object can be accomplished by giving an additional pressure to a melting resin present in a mold cavity from a side of said cavity during or after injecting said melting resin into said mold cavity, or during or after flowing said melting resin into said mold cavity, and thereby the present invention has been obtained.

The present invention is a process for producing a light transmitting plate comprising the steps of:

(1) connecting a cylinder of an injection unit with a cavity of a mold having a diagonal length of from 14 inches (355 mm) to 30 inches (760 mm), wherein (i) said mold is for making a light transmitting plate for a liquid crystal display, (ii) said mold comprises a fixed mold and a movable mold, and (iii) a cavity side of at least one mold of said fixed mold and said movable mold has a rough pattern on its surface,

(2) supplying a transparent resin to said cylinder, and melting said resin,

(3) filling said resin into said mold cavity from said cylinder at an injection rate of from 1 to 15 cm³/sec per one light transmitting plate, wherein said resin passing through an inlet of said mold has a viscosity of from 50 to 5000 Pa·sec,

(4) pressing additionally, said resin present in said mold cavity from a side of said cavity during or after the above-mentioned filling, and

(5) cooling said resin under holding said pressure to solidify said resin, thereby obtaining a light transmitting plate having said rough pattern on its surface. Hereinafter, this process is referred to as “process-1”.

Also, the present invention is a process for producing a light transmitting plate comprising the steps of:

(1) connecting a cylinder of an injection unit with a cavity of a mold having a diagonal length of from 14 inches (355 mm) to 30 inches (760 mm), wherein (i) said mold is for making a light transmitting plate for a liquid crystal display, (ii) said mold comprises a fixed mold and a movable mold, and (iii) a cavity side of at least one mold of said fixed mold and said movable mold has a rough pattern on its surface,

(2) supplying a transparent resin to said cylinder, and melting said resin,

(3) flowing continuously said resin into said mold cavity from said cylinder by rotation of a screw present in said cylinder,

(4) pressing additionally said resin present in said mold cavity from a side of said cavity during or after the above-mentioned flowing, and

(5) cooling said resin under holding said pressure to solidify said resin, thereby obtaining a light transmitting plate having said rough pattern on its surface. Hereinafter, this process is referred to as “process-2”.

### BRIEF DESCRIPTION OF THE DRAWINGS

FIG. 1 is a schematic sectional drawing, which shows an arrangement of a liquid crystal display and a light transmitting plate, wherein FIG. 1(a) is an example using a wedge-like shaped light transmitting plate, and FIG. 1(b) is an example using a sheet-like shaped light transmitting plate.

FIG. 2 is a schematic longitudinally sectional drawing, which shows an example of a molding apparatus used suitably in the present invention.

FIG. 3 is a schematic longitudinally sectional drawing, which shows an example of a mold and a toggle clamp.

FIG. 4 is a schematic plane drawing, which shows an example of a mold arrangement for making two light transmitting plates.

FIG. 5 is a schematic cross sectional drawing, which shows an example of a mold for making two light transmitting plates.

FIG. 6 is a schematic oblique drawing, which shows an example of a molded light transmitting plate obtained immediately after release from a mold in accordance with the present invention.

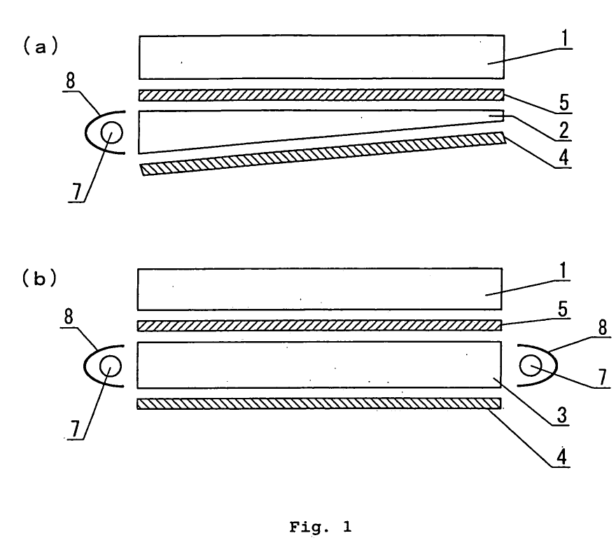

Respective numbers contained in these figures mean: 1 - - - liquid crystal display, 2 and 3 - - - light transmitting plate, 7 - - - light source, 10 - - - injection unit, 12 - - - screw, 13 - - - motor, 14 - - - ram mechanism, 15 - - - hopper, 16 - - - heater, 18 - - - injection nozzle, 20 - - - mold, 21 - - - fixed mold, 22 - - - movable mold, 23 - - - heating barrel, 24 - - - hot tip bushing, 25 - - - hot runner, 26 - - - sprue, 27 - - - runner, 28 - - - gate, 29 - - - cavity, 31 - - - fixed plate, 32 - - - cavity block on a fixed side, 33 - - - cavity block on a movable side, 34 - - - fluid passageway for heat transfer medium and coolant, 36 - - - cavity plate, 37 - - - sliding core, 38 - - - ejector pin, 40 - - - clamping apparatus, 41 - - - movable platen, 42 - - - hydraulic cylinder, 43 - - - hydraulic ram, 44 - - - ejector apparatus, 45 - - - arm, 46 - - - rail, 47 - - - tie bar, 48 - - - base plate, 50 - - - molded light transmitting plate, 51 - - - sprue, 52 - - - gate, 53 - - - main body of a patterned light transmitting plate, and 54 - - - clamping part.

### DETAILED DESCRIPTION OF THE INVENTION

The term “injection rate” used in the above process-1 means an average injection speed between the beginning of filling a melting transparent resin into a mold cavity and the end thereof. Said injection rate is from 1 to 15 cm³/sec, and preferably from 4 to 11 cm³/sec. The injection rate in the present invention is much slower than a conventional injection rate (at least 20 cm³/sec) in an injection molding method; namely, in the present invention, although a melting transparent resin is injected according to a conventional injection molding method, said resin is injected into a mold cavity at a low speed. An example of a method for pressing additionally in the above step (4) is an injection compression molding method in a wide sense.

One of requirements in the above-mentioned process-1 is to fill a melting resin into a mold at an extremely slow speed. An example of said process is a process comprising the steps of (i) measuring and accumulating a resin by rotation of a screw installed in a cylinder using a conventional injection molding machine, and (ii) moving the screw forward at a far lower speed than that in a conventional injection molding under keeping a melting condition of the resin to fill the melting resin in the mold cavity.

The above-mentioned process-2 comprises the step of flowing a melting resin into a mold cavity by a forward-moving force generated by a rotating screw.

A melting transparent resin in the above process-2 is not injected according to a conventional injection molding method, but flowed continuously at a low speed into a mold cavity by rotation of a screw present in a cylinder. It is preferable in the process-2 to regulate a temperature of a transparent resin flowed into a cavity by a method comprising the steps of (i) flowing continuously a melting transparent resin into a cavity under a condition that a surface temperature of said cavity is raised nearly to a glass transition temperature of said transparent resin, and (ii) after completion of said flowing, lowering the surface temperature of said cavity to a temperature lower than said glass transition temperature. This method has the following advantages, comparing with a process not comprising the step of pressuring additionally from a side of a cavity: (1) a sink mark is hardly made, (2) there can be obtained a light transmitting plate having superior appearance, large thickness and large area, (3) a rough pattern is satisfactorily copied, (4) a heat exchange efficiency (mentioned hereinafter) is high, (5) molding can be carries out under a low clamping force, and (6) production efficiency is high. An example of a method for flowing in the step (3) of the process-2 is a flow molding method. An example of a method for pressing additionally in the step (4) thereof is an injection compression molding method in a wide sense.

The transparent resin in the present invention is a resin having physical properties required for a light transmitting plate. An example of said resin is a melt-moldable thermoplastic resin such as a methacrylic resin, a polycarbonate resin, a polystyrene resin, a copolymer resin (MS resin) of methyl methacrylate and styrene, an amorphous cycloolefine-based polymer resin, a polypropylene resin; a polyethylene resin, a high density polyethylene resin, a copolymer resin (ABS resin) of acrylonitrile, butadiene and styrene, a polysulfone resin, and a thermoplastic polyester resin. The above-mentioned methacrylic resin means a polymer containing a polymerization unit of methyl methacrylate as a main polymerization unit. Examples of said polymer are a homopolymr of methyl methacrylate, and a copolymer of methyl methacrylate and a small amount (for example, up to about 10% by weight) of a monomer such as alkyl acrylates (for example, methyl acrylate and ethyl methacrylate) Each of said transparent resins may be used, if necessary, in combination with an agent such as mold release agents, ultraviolet absorbers, pigments, retarders, chain transfer agents, antioxidants and fire retardants.

When the injection rate is lower than 1 cm³/sec, there may occur poor appearance such as a short shot and a f low mark, and insufficient accuracy in thickness and dimension. When the injection rate is higher than 15 cm³/sec, there may occur a sink mark and insufficient accuracy in thickness and dimension. The injection rate is obtained by dividing a volume (cm³) of a molded article by a filling time (second) required for filling a transparent resin, wherein said volume is obtained based on weight of said molded article and a specific gravity of said transparent resin. Even if the same mold is used, the above-mentioned weigh is variable depending upon the above-mentioned filling time, and therefore, the most suitable injection rate can be determined by carrying out a simple pre-experiment.

A viscosity of the melting resin in the step (3) of the process-1 is from 50 to 5000 Pa·sec in order to produce a light transmitting plate having large thickness and no sink mark. When said viscosity is lower than 50 Pa·sec, temperature of the melting resin is too high. When said viscosity is higher than 5000 Pa·sec, the melting resin is solidified before the melting resin reaches all corners of a mold cavity.

The above-mentioned viscosity is obtained by a method comprising the steps of:

(1) calculating a linear velocity (cm/sec) at an inlet of a mold based on an injection rate (cm³/sec) and a sectional area (cm²) of the inlet of the mold according to the following formula (i),

linear velocity=injection rate/sectional area (i)

(2) calculating simply a shear rate (sec⁻¹) of a transparent resin at the inlet of the mold based on said linear velocity and thickness (cm) of the inlet of the mold according to the following formula (ii), and

shear rate=linear velocity/thickness/2 (ii)

(3) obtaining a viscosity at said shear rate based on a relation (obtained by a capillography) between a viscosity of said transparent resin and a shear rate.

A pressure given to a mold (internal mold pressure) in the present invention is lower than that in a conventional injection molding method because of (i) a slow filling speed of a transparent resin in the step (3) in the process-1, or a slow flowing speed thereof in the step (3) in the process-2, and (ii) an additional pressure given to a whole surface of said mold in the step (4), and therefore, a light transmitting plate can be produced by a relatively low clamping force. When pressure of an injection unit is insufficient for giving an injection pressure for a long time at a low velocity, an auxiliary pressure equipment such as an accumulator may be added. Further, a low speed injection-filling method (process-1 in accordance with the present invention) may be combined with a method of flowing a transparent resin into a mold by rotation of a screw present in a cylinder (process-2 in accordance with the present invention) by reconstructing ROM (read only memory) for operating a motor in a conventional injection molding machine.

Since a flow of a melting transparent resin is stopped in a less probability in the process-2, a rough pattern is copied more preferably. In the process-2, the flowing in the step (3) is carried out under ceaseless pressure generated by a screw rotation, and therefore, there can be produced a light transmitting plate having a larger volume than a cylinder volume by continuing said screw rotation. Further, a pressure given to a mold (internal mold pressure) maybe about a half of a pressure in a conventional injection molding method, and therefore, a light transmitting plate having a large area can be produced by a low clamping force. A molding machine used for the process-2 can be obtained by reconstructing ROM (read only memory) for operating a motor in a conventional injection molding machine so as to satisfy needs for the process-2.

Examples of the rough pattern in the present invention are a dot and a line. Said rough pattern copied on a light transmitting plate corresponds to a pattern present on a reflection layer to reflect light passing through said light transmitting plate toward a side of a liquid crystal display, or corresponds to a pattern present on a light diffusion layer to diffuse and emit light on the front side (emitting side) of said light transmitting plate. In the present invention, it is possible to copy both a pattern on a reflection layer and a pattern on a light diffusion layer at the same time by using a mold having rough patterns on its both cavity surfaces.

A rough pattern in the present invention can be made directly on an inner surface of a mold. However, in order to, for example, make a rough patter easily, or exchange with another different rough pattern easily, it is preferable to (i) set a separately prepared cavity plate having a rough pattern on its surface inside a mold, or (ii) laminate said cavity plate with an inner surface of a mold. Examples of a method for making a rough pattern on a cavity plate are a stamper method, a sand blast method, an etching method, a laser processing method, a milling method and an electroforming method. An example of a method for designing such a rough pattern is an optical simulation method. For example, a pattern present on a reflection layer in place of printing can diffuse an emitting light uniformly as a whole area by giving a density and a size to a light-diffusing pattern, which density and size are increased together with an increase of distance from a light source of a cold cathode-ray tube. A material used for making a cavity plate may be any material suitable for making said rough pattern, and its thickness is preferably as thin as possible, for example, from about 0.5 to about 5 mm.

A cavity side of a mold having no rough pattern has preferably a plated mirror plane in order to (i) obtain a light transmitting plate having a superior mirror plane, and (ii) improve a mold releasing property. Examples of a material for a plated layer are titanium carbide (TiC), titanium nitride carbide (TiCN), titanium nitride (TiN), tungsten carbide (W₂C), chromium (Cr) and nickel (Ni). Said plated layer is preferably polished.

A transparent resin filled or flowed into a cavity is heated and cooled through said cavity side of a mold, and therefore, heat exchange of a light transmitting plate depends upon a thermal conductivity in the vicinity of the cavity side. Since an injection rate of a melting resin in the process in accordance with the present invention is extremely slower than that in a conventional injection molding method, it is difficult to copy a rough pattern satisfactorily on a surface of a light transmitting plate only by a cooling effect due to contact of said melting resin with a mold. Therefore, it is preferable in the present invention to regulate temperature of a transparent resin contained in a cavity by a method comprising the steps of (1) filling or flowing said resin in to a cavity under a condition that a surface temperature of a mold cavity is about a glass transition temperature (Tg ° C.) of said resin, namely, between Tg−5° C. and Tg+25° C., and then, (2) lowering said surface temperature of a mold cavity to a temperature lower by at least 50° C. than the glass transition temperature (Tg ° C.) of said resin.

An example of the above-mentioned temperature-regulating method is a so-called heat transfer medium/coolant exchanging method, which comprises the step of passing a heat transfer medium and a coolant alternately through a passageway (fluid passageway) installed in the vicinity of an inside of a mold cavity. A molding method according to such a temperature-regulating method is called a cooling-heating cycle molding method. Examples of said heat transfer medium and said coolant are oil for a machine and water. Among them, water is preferable as the coolant, and pressurized water is preferable as the heat transfer medium.

In said cooling-heating cycle molding method, it is preferable to use a metal such as copper or its alloy in the vicinity of a mold cavity side (particularly, around a fluid passageway), which metal has a larger thermal conductivity than that of a metal (generally, steel material) constituting a main body (mold base) of a mold. Particularly, preferred is beryllium-copper (namely, a copper alloy containing beryllium in an amount of from about 0.3 to about 3% by weight), which alloy has from three to six times as a large thermal conductivity as a general steel material. Specifically, there is arranged a cavity block in the vicinity of a mold cavity side, which cavity block (i) is made of a different material (for example, beryllium-copper) from a material constituting a main body of a mold, and (ii) has a fluid passageway inside it. Such an arrangement can raise or lower a temperature in about a half time of a time required for a conventional cavity side made of a steel material.

In the present invention, in order to copy the above-mentioned rough pattern further preferably and uniformly, an additional pressure is given from a side of a cavity during or after filling in the step (4) of the process-1, and during or after flowing in the step (4) of the process-2, respectively. An example of a method for giving said additional pressure is a method used in a conventional injection compression molding method.

An injection compression molding method is a kind of a low pressure molding method. The injection compression molding method is classified roughly into two methods, namely, (1) a method comprising the steps of (i) filling up easily a melting resin into a cavity by expanding temporarily said cavity slightly, and then (ii) pressing and compressing a partial side or a total side of a molded article to give a predetermined shape, and (2) a method comprising the steps of (i) injecting a melting resin into a mold cavity opened previously by one compression stroke, (ii) closing the mold during or after filling up said resin, and then (iii) compressing with a clamping force. The former method is an injection compression method in a narrow sense, and the latter method is generally called an injection pressing method. An injection compression molding method is classified into three methods, namely, a Rolinx process, a micromold system, and an injection pressing method.

The Rolinx process is classified into two methods, namely, (1) a method comprising the steps of (i) injecting a melting resin without opening a parting plane of a mold, and then (ii) pressing and compressing, and (2) a method comprising the steps of (i) injecting a melting resin under opening slightly a parting plane thereof, and then (ii) pressing and compressing. The former method comprise the steps of (i) injecting a melting resin into a mold maintained with a weak clamping force, whereby a parting line is opened automatically during a filling process by a weaker clamping force than an injection pressure, and then (ii) after completion of the filling, compressing an expanded cavity by changing to a strong clamping force. In this method, a parting plane is pressed by, for example, a hydraulic cylinder or a spring in order to get no flash out of the parting plane of a mold. A more general Rolinx process comprise the steps of (i) filling a melting resin into a mold cavity under opening slightly a parting plane, and then (ii) changing to a strong clamping force, whereby the mold is closed completely, and the resin contained in the cavity is pressed. In this case., there is used a press-cut typed mold in order to make no flash, wherein a cavity and a core of the mold have a counter lock structure.

The micromold system is a method comprising the steps of (i) injecting a predetermined amount of a melting resin under closing a parting plane of a mold, then (ii) compressing a part of the resin with another independently existing pressure equipment, and then (iii) pressing and compressing. In this system, only a part of the filled resin is compressed.

In the injection pressing method, molding is almost carried out with a mold clamping mechanism or a clamping force of a press. A general method thereof comprises the steps of (i) injecting a melting resin into a mold cavity opened by one compression stroke, then (ii) closing the mold by moving a movable mold during or after filling said resin, and then (iii) compressing with a clamping force. Its mold structure is almost the same as that in the Rolinx process having an opened parting side, and a parting side of the mold has a press-cut type. This method is suitable for a thin molded article having a large projected area.

Examples of advantages of these injection compression molding methods are generally an improvement of a copying ability and optical properties; decrease of a weld line, a flash and deformation; and downsizing of a molding machine due to a low pressure molding. Since a light transmitting plate in the present invention has a rough pattern on its one surface and an evenness on its another surface, or has a rough pattern on its both surfaces, it is preferable to give pressure uniformly to a total area of respective surfaces. Accordingly, preferred is a method comprising the step of pressing all sides of a cavity during compression. Specifically, preferred are (1) the above-mentioned Rolinx process, which is an injection compression process comprising the step of pressing a total area, and (2) an injection press method comprising the steps of (i) injecting a melting resin into a mold cavity opened by one compression stroke, and then (ii) compressing.

When filling or flowing a melting resin into a mold cavity, carbon dioxide may be injected into the mold cavity (JP 10-128783-A and JP 11-245256-A). Said injection of carbon dioxide has a good effect on (1) a method of filling a melting resin into a mold cavity by a rotation-transfer function of a screw in an injection cylinder, and (2) a method of filling a melting resin into a mold cavity at an extremely low speed as disclosed in JP 2002-11769-A and JP 2002-46259-A. However, in the present invention, a combination of (1) the steps of (i) filling a resin at a slow speed, and then (ii) compressing a mold subsequently with (2) a mold temperature-regulating mechanism further improves a copying ability, and further lowers an injected resin temperature.

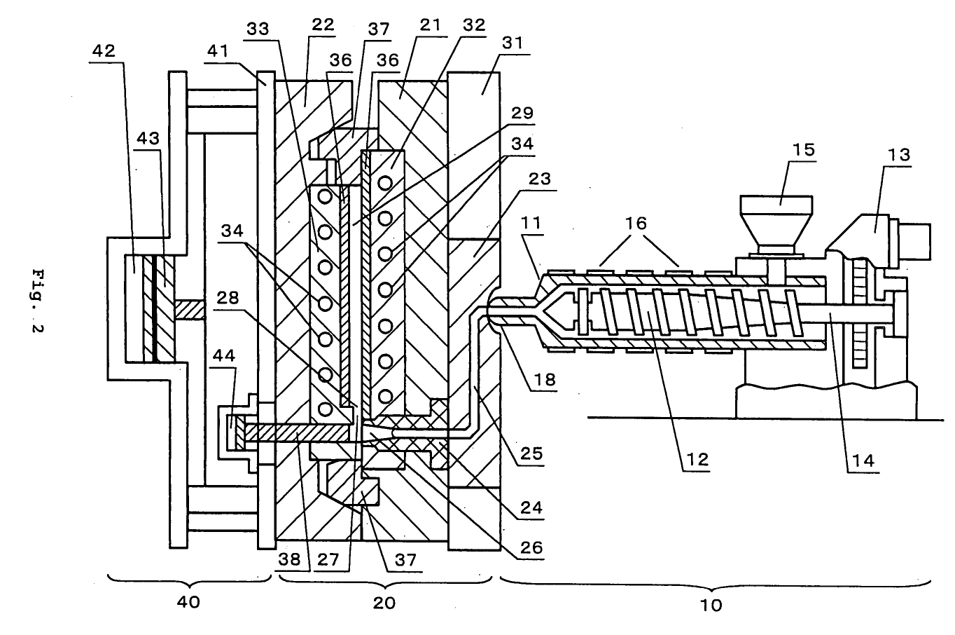

The present invention is further explained referring to FIG. 2. This figure is a longitudinally sectional schematic drawing, which shows an example of a molding apparatus suitable for the present invention. This apparatus is roughly divided into an injection unit 10, a mold 20 and a clamping apparatus 40.

The injection unit 10 comprises mainly an injection cylinder 11, a screw 12 in the injection cylinder, a motor 13 for rotating the screw, a ram mechanism 14 for moving the screw forward, a hopper 15 for supplying a transparent resin to the injection cylinder 11, heaters 16 set outside the injection cylinder, and an injection nozzle 18, which is present at the end of the injection cylinder and injects a melting resin.

A mold 20 comprises a fixed mold 21 and a movable mold 22. On the side of the fixed mold 21, a heating barrel 23 (heated) for passing a melting resin injected from the injection nozzle 18, and a hot runner 25 (heated) set in a hot tip bushing 24. At its end, there is formed a sprue 26, which sectional area increases gradually in a taper configuration toward the movable mold 22. The hot tip bushing 24 may have a structure of a general open-gate form, however, in order to protect a resin from flowing backward from the gate during compression molding in the mold, preferred is a structure such as a valve-gate form, wherein a gate is opened when necessary, and is closed in a step such as a step after a pressure-holding step not-necessitating said opening.

A runner 27 is formed on a connecting side of the fixed mold 21 and the movable mold 22 along the both molds 21 and 22. The runner 27 is connected with the sprue 26, which opposite end is a gate 28. There is formed a cavity 29 for a molded article by connecting the fixed mold 21 with the movable mold 22, and the cavity 29 is connected with the gate 28. Therefore, this example shows that the cavity 29 is connected with the cylinder 11 of the injection unit 10 through the gate 28, the runner 27, the sprue 26 and the hot runner 25. The fixed mold 21 is fixed on a fixed plate 31, and a cavity block 32 on the fixed side is set on the side of the cavity 29 thereof. On the other hand, the movable mold 22 is fixed on a movable plate 41, and a cavity block 33 on the movable side is set on the side of the cavity 29 thereof. A mold is opened or closed by the movable plate 41, which is moved forward or backward by a clamping apparatus 40 mentioned below.

A fluid passageway 34 for a heat transfer medium and a coolant is installed inside the cavity block 32 of the fixed mold 21 and the cavity block 33 of the movable mold 22 along the cavity 29. A mold temperature, more specifically a surface temperature of a cavity plate 36 is raised or lowered depending upon an object during a molding cycle by passing alternately a heat transfer medium and a coolant through the fluid passageway 34 by a temperature-regulating equipment having a controller. As mentioned above, it is preferable that the cavity block 32 of the fixed mold and the cavity block 33 of the movable mold comprise a metal such as a beryllium-copper alloy having a higher thermal conductivity than that of a metal (for example, steel material) constituting the main bodies 21 and 22 of the mold. Although it is preferable to set the fluid passageway 34 in both of the cavity block 32 of the fixed mold and the cavity block 33 of the movable mold, a corresponding good effect can be obtained by installing the fluid passageway in either one thereof and passing alternately a heat transfer medium and a coolant therethrough.

A side of the cavity 29 of the cavity block 32 of the fixed mold and that of the cavity block 33 of the movable mold comprise the cavity plates 36 and 36, which form a rough pattern for a pattern of a reflection layer or a pattern of a light diffusion layer on either side or both sides of a light transmitting plate. Said cavity plates are inserted in a mold, or laminated with a mold. The cavity plates 36 and 36 may be made of a material having a high thermal conductivity such as a beryllium-copper alloy, or a plate such as a stainless steel-made plate having preformed various rough patterns may be laminated with a surface of the cavity blocks 32 and 33 made of a high thermal conductivity-carrying metal. The cavity plates 36 and 36 may be set on a side forming a rough pattern for a pattern of a reflection layer or a pattern of a light diffusion layer. For example, when a light transmitting plate has a rough pattern in its one side and has an even surface in its another side, a cavity side corresponding said even surface may have a cavity plate 36, or a cavity block 32 or 33 may have a metal surface, or the cavity block 32 or 33 may have a plated surface on its surface.

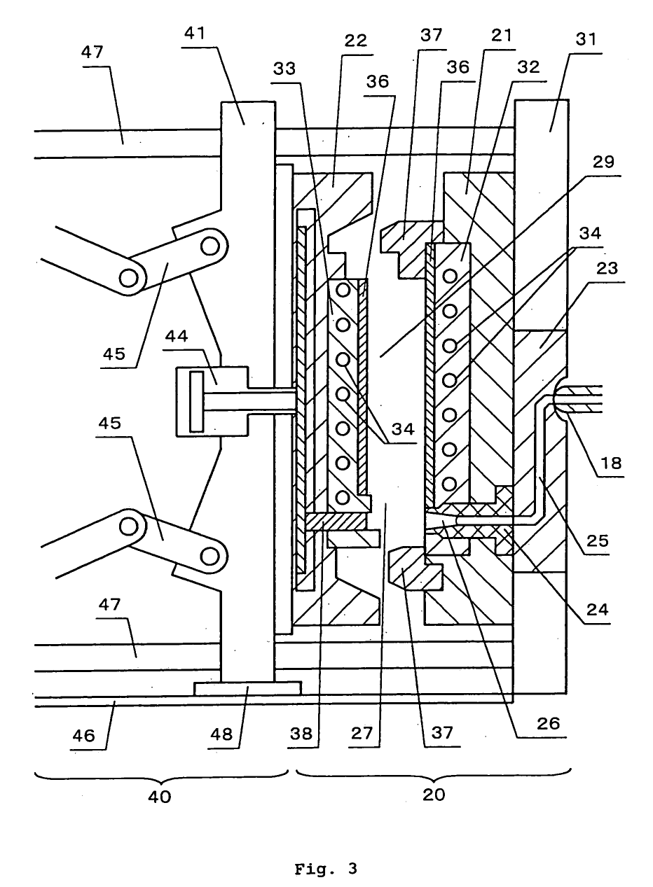

In the present invention, a connecting side of a fixed mold 21 with a movable mold 22 preferably has a press-cut type of a counter lock structure in order to make no flash, because a resin is filled in the presence of a clearance made by opening a mold in advance. FIG. 2 shows an example, which makes a counter lock structure by arranging sliding cores 37 and 37 in a connecting side of the fixed mold 21 with the movable mold 22. Namely, the present invention has an angular structure, wherein an inclining part of the sliding cores 37 and 37 have the same slope as that of an inclining part of the movable mold 22, whereby the sliding cores 37 and 37 (end side of the mold) slide gradually toward a product cavity together with compressing the mold by moving the movable mold 22 toward the fixed mold 21, to fill a clearance. Conversely, when the mold is opened, the sliding core 37 contacted with a side end of a molded article slides to release the molded article. In this example, the sliding cores 37 and 37 are set on the side of the fixed mold 21 in order to get no resin out of a parting when compressing under the condition that the mold is slightly opened (see also FIG. 3). An end side of the moving part (an outer side of a product) is designed to form a clearance of from about 20 to about 200 μm in order to get no resin out of the clearance when the parting is opened in a maximum width of 1000 μm.

An inside of the movable mold 22 opposing the sprue 26 has an ejector pin 38 to extrude a product. The ejector pin 38 is moved forward or backward by an ejector apparatus.

A clamping apparatus 40 comprises mainly a movable plate 41, a hydraulic cylinder 42 and a hydraulic ram 43 moving forward or backward in the hydraulic cylinder 42. A positioning sensor (not shown in the figure) is arranged at a predetermined position between the movable plate 41 and the hydraulic ram 43, whereby a position of the movable plate 41 is detected. When closing the mold 20, a melting resin is injected and filled under the condition that the movable plate 41 is opened in a predetermined degree according to the positioning sensor, and when an optional predetermined time has been reached, the movable plate 41 is further clamped, and as a result, the melting resin in the mold cavity 29 is further pressed. At this time, an additional pressure may be given from the above-mentioned ejector pin 38 by pressing it.

Although FIG. 2 shows a hydraulic mold clamping mechanism, there may be used a toggle clamp, which clamps mechanically with an arm. FIG. 3 is a schematic longitudinally sectional drawing showing an example in such a case. FIG. 3 shows only the injection nozzle 18 of an injection unit, and other parts thereof are omitted. This figure shows an opened mold 20. Since the mold 20 is similar to that shown in FIG. 2 except that (1) the mold is opened, and (2) an ejector apparatus 44 is arranged in the center of the movable plate 41, the same numbers as those in FIG. 2 are given to the same parts as those in FIG. 2, and therefore, detailed explanations are omitted.

The clamping apparatus 40 shown in FIG. 3 comprises mainly a movable plate 41, a pair of arms 45 and 45 for moving said arms forward or backward, a rail 46 for moving the movable plate 41 carrying thereon, and a pair of tie bars 47 and 47. A lower end of the movable plate 41 is put on the rail 46 through a base plate 48, and is moved in a clamping direction or a mold opening direction by expansion or contraction of the arms 45 and 45.

Next, an explanation is made about a method for molding a large-sized light transmitting plate having a copied pattern using a molding machine comprising the injection unit 10, the mold 20 and the clamping apparatus 40 as shown in FIG. 2 or FIG. 3. First, a heat transfer medium is passed though the fluid passageway 34 in the mold 20, whereby the vicinity of the cavity 29 is heated to a predetermined temperature. When clamping the mold 20, a temporary clamping is carried out under a condition that the movable plate 41 is opened in a predetermined degree by a positioning sensor (not shown in the figure).

Then, in case that a screw rotation is not utilized in injection of a melting resin, the screw 12 is rotated by the motor 13, and a transparent resin is supplied to the injection cylinder 11 from the hopper 15. Said supplied resin is plasticized and melt-kneaded by heating with the heater 16, shear heating given by rotation of the screw 12, and frictional heating given thereby, then, is transferred by rotation of the screw 12 toward the end thereof, and then, is measured in a predetermined amount. Thereafter, the screw 12 is moved forward by the ram mechanism 14, and the melting resin is injected and flowed into the mold. The injected melting resin is transferred continuously toward the cavity 29 through the hot runner 25, the sprue 26, the runner 27 and the gate 28. In this embodiment, a viscosity of the melting resin passing through the gate 28 is assigned to be from 50 to 5000 Pa·sec, and an injection rate per one molded article is assigned to be from 1 to 15 cm³/sec, and preferably from 4 to 11 cm³/sec.

On the other hand, in case that the screw rotation is utilized in injection of the melting resin as well, the screw 12 is rotated by the motor 13 under the condition that the screw 12 exists almost at the most forward position, and the transparent resin is supplied to the injection cylinder 11 from the hopper 15. Said supplied resin is plasticized and melt-kneaded by heating with the heater 16, shear heating given by rotation of the screw 12, and frictional heating given thereby, then, is transferred by rotation of the screw 12 toward the end thereof, and then, is transferred continuously toward the cavity 29 through the hot runner 25, the sprue 26, the runner 27 and the gate 28. At that time, it is preferable to give a back pressure higher than the predetermined pressure from the back part of the screw 12 in order to protect the screw 12 from moving backward by the pressure of the resin transferred toward the front of the screw 12, namely, in order to keep the screw 12 at said position. Specifically, there is given such a back pressure that the screw 12 is not moved backward by the pressure of the resin under filling, but moved backward by the pressure of the filled resin. In this case, preferred is a method such as a flow molding method, wherein the melting resin is continuously flowed into the mold cavity 29 under rotation of the screw 12 in the cylinder 11 of the injection unit.

In such a case wherein the melting resin is continuously flowed into the mold cavity 29 under the rotation of the screw 12 in the cylinder 11, the rotation speed of the screw is related to a flow injection speed, and the higher the rotation speed of the screw is, the higher the flow injection speed is. The rotation speed of the screw is suitably selected generally from a value range of from about 20 to about 180 rpm according to conditions such as a diameter of the screw, thickness of a molded article and numbers of said articles molded by one mold. The rotation speed of the screw is preferably not more than 150 rpm, and more preferably about 35 rpm. When molding two or more articles using one mold such as two articles, the rotation speed of the screw is adjusted so as to obtain a predetermined injection ratio per one molded article.

It is preferable in any embodiment to set a temperature of a mold under flowing a melting resin, specifically, a surface temperature of the cavity plates 36 and 36, at a temperature not lower than a glass transition temperature of the resin. However, in connection with a molding cycle, said temperature at the beginning of an injection may be a temperature not higher than the glass transition temperature thereof. It is necessary, at least before the next pressure-keeping step is carried out, to set a surface temperature of the cavity plates 36 and 36 on the side of the cavity 29 at a temperature not lower than a glass transition temperature of a resin. Further, it is preferable to improve a temperature-regulating system so as to raise or lower a temperature more quickly.

A surface temperature of a mold depends on a kind of a transparent resin used, and it is generally from about 90 to about 150° C. In case of a methacrylic resin, its glass transition temperature is about 105° C., and therefore, the surface temperature of a mold is preferably from about 105 to about 130° C. Also, an injection temperature of a melting resin (resin temperature in the injection cylinder 11) depends on a kind of a transparent resin used, and it is generally from about 170 to about 300° C. In case of a methacrylic resin, for example, it is from about 200 to about 300° C., and preferably from about 220 to about 270° C. A back pressure at that time is from about 20 to about 45 MPa in terms of a resin pressure at the front end of a screw.

Regarding regulation of a temperature of a mold, a heat transfer medium is passed through the fluid passageway 34, whereby a cavity surface temperature of a mold is raised nearly to a glass transition temperature of a resin. For example, in case of a methacrylic resin, said cavity surface temperature is raised to about 100° C. by passing a heat transfer medium such as pressurized water heated at a temperature not lower than 100° C. specifically from about 110 to about 130° C. through the fluid passageway 34. When this temperature has been reached, filling of a resin (injection or screw rotation) is started. When the resin is filled under these conditions, a surface temperature of a mold can be maintained at a higher temperature than that before starting the above-mentioned filling, namely, at a temperature not lower than a glass transition temperature of a resin, for example, in case of methacrylic resin, at a temperature of from about 105 to about 130° C., because a temperature of a resin flowed into a cavity is higher than the above-mentioned cavity surface temperature. After completion of the filling, the mold cavity 29 is rapidly cooled by changing a valve installed on the way of the fluid passageway 34, and passing a coolant having a temperature of from about 10 to about 40° C. such as water through the fluid passageway 34. After cooling sufficiently, the mold is opened at a proper mold temperature under passing again the heat transfer medium through the fluid passageway 34 by changing the valve, and then, a molded article is taken out by extrusion. When a mold temperature has been reached an enough temperature to fill a resin, the next cycle is started.

A pressure-holding step is started under a condition that a cavity 29 has not been completely filled, namely, under a condition of a short shot. At the same time, the mold 20 is gradually clamped completely by the movable plate 41, whereby a melting resin in the cavity 29 is compressed in its thickness direction, and also, a proper holding pressure is added. It is preferable to give an additional pressure from a side of a cavity after an injection simultaneously with the addition of the holding pressure from a side of an injection cylinder, from a viewpoint that a clamping force for giving the additional pressure from a side of a cavity is lowered, because the holding pressure itself is lowered, and molding can be carried out under a low pressure. When flowing continuously a melting resin into a mold cavity under rotation of a screw in a cylinder, the screw 12 is slightly moved backward by a filled resin pressure, and therefore, a holding pressure is added when the screw 12 is moved backward by a predetermined distance.

At the beginning of the addition of a holding pressure, a medium passing through fluid passageway 34 is changed to a coolant by a method such as setting a timer or changing a switch valve. Compression of a mold and a holding pressure are maintained for a predetermined time, and a coolant is passed through the fluid passageway 34 so that a surface temperature of a mold cavity at the time of completion of the pressure holding reaches a temperature not higher than a glass transition temperature of a resin. After completion of maintenance of the holding pressure and compression, the fixed mold 21 and the movable mold 22 are kept closed further for a time required for cooling, for example, from about 5 to about 150 seconds, and preferably from about 20 to about 80 seconds, depending upon thickness of a product.

When a predetermined cooling time has passed to cool the molded article down to a temperature, at which the molded article taken out is not deformed, the movable mold 22 is opened, and the molded article is taken out by extruding with the ejector pin 38. After taking out the molded article, a medium in the fluid passageway 34 is changed to a heat transfer medium, whereby a surface temperature of a cavity is raised again to a temperature preferably not lower than a glass transition temperature of a resin, then the movable mold 22 is closed, and then the next cycle is started to make a molded article. Incidentally, there is permitted a process comprising the steps of (i) cooling down to a lower temperature than a temperature at which a molded article is taken out, (ii) changing a medium in the fluid passageway 34 from a coolant to a heat transfer medium under a condition that a molded article exists in a cavity 29, and (iii) taking out the molded article during raising a temperature.

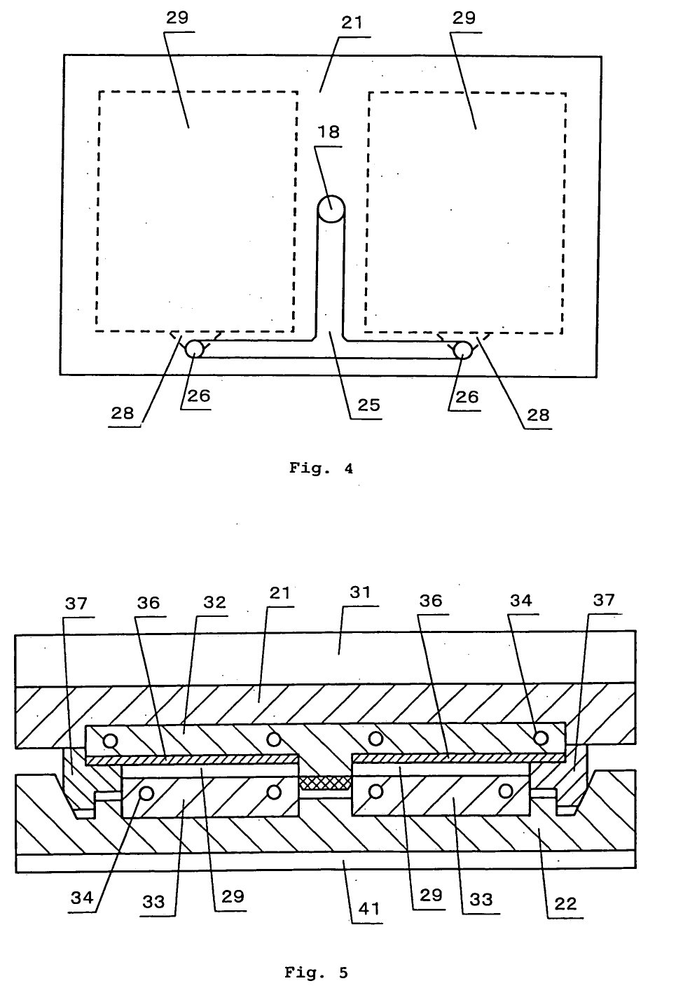

FIG. 4 is a schematic plane drawing, which shows an example of a mold arrangement for making two products (light transmitting plates). In this case, there is allowed a process comprising the steps of (i) dividing a melting resin injected from the injection nozzle 18 into two channels on the way of the hot runner 25, and (ii) flowing the melting resin into the cavities 29 and 29 through the sprues 26 and 26 and the gates 28 and 28 corresponding to the cavities 29 and 29. A mold for making three or more products may be designed according to this example.

FIG. 5 is a schematic cross sectional drawing, which shows an example of a mold for making two light transmitting plates. This drawing corresponds roughly to a cross sectional drawing of only the mold 20 in the molding unit shown in the longitudinally sectional drawing of FIG. 2. In FIG. 5, the same numbers as those in FIG. 2 are given to the same parts as those in FIG. 2, and therefore, detailed explanations are omitted. In this example, the cavity block 32 on the side of the fixed mold 21 is constituted with one body having a nose in its center, whereby the cavities 29 and 29 have a divided structure. A small clearance is made on a boundary between the cavities 29 and 29, and a press-cut typed counter lock structure is also made at this part. Incidentally, this example has the cavity plates 36 and 36 of the cavity sides only on the cavity block 32 on the fixed side.

A process for making one molded article comprises the steps of (i) passing a medium (heat transfer medium) having a temperature not lower than a glass transition temperature of a resin through a fluid passageway in a mold, (ii) supplying the resin to a cylinder under a condition that a surface temperature of a mold cavity is raised to a temperature nearly equal to said glass transition temperature or higher than that, and (iii) injecting and filling a melting resin into the mold cavity. In this case, when using an embodiment wherein the melting resin is flowed into the mold cavity under rotation of a screw in a cylinder, there are simultaneously carried out (1) supply of the resin to the cylinder by rotation of a screw, and (2) injection and filling of the melting resin into the mold cavity. At that time, the mold is opened previously according to a compression molding method, or a low clamping force is set up so that the mold is opened by a resin pressure under filling, wherein a clearance between a fixed mold and a movable mold exists. And, after the melting resin has been filled up to the ends such as corners of the mold cavity, or during said filling, a holding pressure is added under compressing the mold parting line. At the beginning of adding the holding pressure, at any time during adding it, or at the time of completion of adding it, a medium passing through the fluid passageway in the mold is changed to a coolant having a temperature not higher than the above-mentioned glass transition temperature, and preferably not higher than a load deflection temperature, and the cooling step is started. Thereafter, the mold is opened, and a molded article is taken out.

A molded article (light transmitting plate) so obtained has a superior accuracy in its thickness and outside dimension, and is stable, because (i) a melting resin is injected and filled into a mold cavity continuously and extremely slowly comparing with a general injection molding method, and therefore, said resin is filled under compensating at all times a volume shrinkage thereof by cooling, and (ii) a compression operation of a mold is adopted. Accordingly, the volume shrinkage is stable, and as a result, a product dimension is stable, and thickness of a product is almost constant. When molding by flowing a transparent resin continuously into a mold cavity under rotation of a screw in a cylinder, a melting resin hardly resides in an injection cylinder comparing with a general injection molding method, because of a simultaneous progress of a step of supplying a resin and a step of injecting it, and therefore, there is obtained a product having a further excellent dimensional stability and high transparency. Further, since at least one surface of this molded article has a copied pattern corresponding to a reflection layer or a light diffusion layer, a following printing step can be omitted. These matters results in a lower total cost per one light transmitting plate, comparing with a light transmitting plate produced from a methacrylic resin sheet by a cutting out method. This molded article also has a small molding strain due to less non-uniformity of density and less anisotropy of a molecular comparing with a general injection molding method, because (i) a resin is filled into a mold cavity at a high temperature, and (ii) a compression operation of a mold is adopted.

Further, the following functions and effects are obtained by (i) injecting a melting resin at an extremely low speed into a mold cavity, and (ii) compressing the mold by giving an additional pressure to the melting resin in the cavity during or after filling:

(1) comparing with a case having no compressing step, a heat exchange efficiency is high, and a time required for cooling a molded article can be shortened, because a surface of the molded article is contacted more tightly with that of the cavity in a step of cooling the molded article, and therefore, a productivity of a light transmitting plate is high, and production having a short cycle time is possible,

(2) respective corners of a molded article are pressurized by compressing all sides of a cavity, and therefore, density is uniform and a sink mark is hardly made, which results in a wide selection of preferable molding conditions and an improved moldability,

(3) a molding strain (residual stress) is uniformly lowered, a molded article having a lower stress and a lower strain is obtained, and a warpage is easily controlled, because of uniform compression of all sides of a molded article,

(4) a rough pattern given to a cavity surface can be copied more uniformly and also at a higher transferring ratio by giving a pressure uniformly to respective ends,

(5) a filling pressure and a holding pressure can be set at a low pressure, because shrinkage of a molded article in its thickness direction accompanied by its volume shrinkage is compensated by compression of a mold itself, and as a result, it is possible to mold under a lower clamping force, and a product having a large-sized area can be prepared using a molding machine having a lower performance than that of a conventional molding machine; in an injection molding method, unless a clamping force not less than (projected area of product×real pressure in a mold) is applied, a mold is defeated by a resin pressure to be opened, and then a resin is leaked, and therefore, there is needed a large-sized molding machine generally having a force of from 450 to 1000 tons to mold a large area-carrying light transmitting plate. However, in case of a low pressure, even a middle class of a molding machine can be applied, and

(6) a wall of a mold is contacted further tightly with a surface of a molded article, and therefore, a heat exchange between a mold and a molded article is further promoted, which results in reduction of a cooling time and accordingly a reduction of a molding cycle.

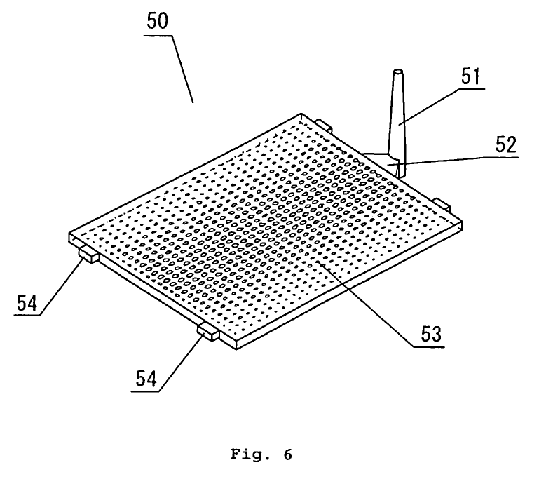

FIG. 6 is a schematic oblique drawing, which shows an example of a molded light transmitting plate produced by a process in accordance with the present invention. The light transmitting plate 50 comprises the sprue 51, the gate 52, the main body 53 of the light transmitting plate, and clamping parts 54 and 54, and the gate 52 is cut off after molding. In this example, a pattern previously given to a cavity plate is copied on the side of the fixed mold of the main body 53. This pattern is determined by an optical simulation, and a kind of the pattern may be a known pattern having a function capable of diffusing an incidence light such as a circle, a triangle and a square, a dotted pattern comprising a combination thereof, a slit-like grooved pattern and a mat-like embossed pattern. In case of the dotted pattern, a diameter of every dot and an arranging density of the dots are generally increased together with increase of a distance from an incident side of a light source.

According to the present invention, there can be produced a large-sized light transmitting plate superior in its properties such as transparency and dimension stability used for a back light unit, which unit is used for a large-sized liquid crystal display having a diagonal length of from 14 inches (355 mm) to 30 inches (760 mm) such as a desk-top personal computer and a liquid crystal display-carrying television set. Further, since the present invention has a constitution such that a rough pattern corresponding to a reflection layer or a light diffusion layer on an emitting side is made on at least one side of mold cavity sides, and said rough pattern is copied on a resin-made molded article, the process can (i) omit a printing step and (ii) shorten a production cycle, and therefore, the present invention is superior in its total production cost. Particularly, because the present invention has a step of compressing a mold during or after filling of the resin (namely, a step of compressing a mold surface in its thickness direction depending upon a volume shrinkage of the resin), and a step of copying the rough pattern of a mold surface on a surface of a molded article, said copy can be further improved. Such an effect is further remarkable when combining with a method comprising the steps of (i) filling a melting resin into a cavity under the condition that surface temperature of the mold cavity is raised to temperature nearly equal to a glass transition temperature of the resin, and (ii) regulating the temperature of the resin filled in the cavity by lowering the surface temperature of the cavity to temperature not higher than the glass transition temperature of the resin, for example, a so-called mold temperature-regulating method by a heat transfer medium/coolant exchange, wherein a fluid passageway is installed near the cavity side inside the mold, and the heat transfer medium and the coolant are passed alternately through the fluid passageway.

### EXAMPLE

The present invention is explained with reference to the following Example, which does not limit the scope of the present invention.

### Example 1

(1) Designing a Mold

In order to carry out the process-2 in accordance with the present invention, ROM of a molding machine, J450 EL 111-890H, manufactured by The Japan Steel Works, Ltd., was reconstructed. The mold had such a size as to be installed to a molding machine having a clamping force of 450 tons, and a cavity was able to produce two light transmitting plates, each thereof having a diagonal length of 15 inches.

A main body of the light transmitting plate had a shape similar to that shown in FIG. 6, and it was designed so as to have a size of 31 cm×24 cm, and thickness of 6 mm.

A mold temperature-regulating system comprised (1) a mold temperature-regulating machine, MCN-150H-OM, manufactured by Matsui MFG. Co., Ltd., on each side of a fixed side and a movable side, (2) a cooling unit of a coolant, MCC3-1500-OM, manufactured by Matsui MFG. Co., Ltd., and (3) a valve stand for exchanging automatically between a heat transfer medium and a coolant.

The above-mentioned mold had a similar constitution to that shown in FIG. 5. The cavity block 32 on the side of the fixed mold 21 was obtained by processing a beryllium-copper alloy having a high thermal conductivity, MP 15, manufactured by NGK Fine Molds, Inc., in thickness of 45 mm. This beryllium-copper alloy is a precipitation hardening alloy, wherein beryllium is solid-solved in copper in an amount of not more than 2% by weight, and further a small amount of an element such as nickel is added. On its cavity side, there was applied a cavity plate for copying a pattern made of a 1.5 mm-thick stainless steel plate, to which a real circle-shaped dotted pattern in place of printing was given in advance by an etching treatment. Said side corresponded to a reflection layer side of a light transmitting plate. Respective dots in said dotted pattern were large in its center of the longitudinal direction, and became smaller with increase of a distance from the center. In the center, said dot had a diameter of about 1.0 mm, and a pitch of about 1.5 mm among the dots. In the end part of the light source side, said dot had a diameter of about 0.6 mm, and a pitch of about 1.5 mm among the dots. The cavity block 33 on the side of the movable mold 22 was obtained by (i) processing a beryllium-copper alloy, 25A (corresponding to C 1720 in JIS), manufactured by NGK Fine Molds, Inc., in thickness of 45 mm, which alloy has the highest strength, and has a higher hardness than the above-mentioned high thermal conductivity-carrying beryllium-copper alloy, (ii) plating its surface (cavity side) with nickel in thickness of about 100 μm, and further (iii) polishing it by about 25 μm. Said plated and polished cavity side corresponded to an emitting side of a light transmitting plate.

The sliding core 37 was made of pre-harden steel, NAK 80, manufactured by Daido Steel Co., Ltd., and its part corresponding to an end side of a molded article was mirror polished. The main bodies 21 and 22 of the mold around those cavity parts were made of a conventional steel material, S 55 C. In order to raise or lower mold temperature during a cycle, there was installed a fluid passageway having a diameter of 14 mm, which was positioned in the cavity block 32 on the fixed side and in the cavity block 33 on the movable side, respectively, at least about 13 mm distance inside from the cavity side. A cooling-heating cycle was obtained by passing through the fluid passageway alternately cold water as a coolant having temperature of about 15° C. supplied from a cooling unit for a coolant, and pressurized water as a heat transfer medium having temperature of about 130° C. supplied from a temperature-regulation unit for a heat transfer medium.

(2) Molding a Resin

The following is a production example of a light transmitting plate using the above-mentioned mold and molding apparatus, and a methacrylic resin. As the resin, a transparent methyl methacrylate resin, SMIPEX MGSS, produced by Sumitomo Chemical Co., Ltd., was used, and temperature of the resin in an injection cylinder was set at 240° C. A screw rotation speed was set at an injection rate of about 10 cm³/sec. When using a mold for producing two molded articles at a time, the injection rate was 20 cm³/sec. The heat transfer medium heated at 130° C. was passed through the fluid passageway, and the molding machine was set so as to be started automatically when a cavity surface temperature measured with a surface thermometer had reached about 100° C.

The movable mold was moved toward the fixed mold side to close the mold, and the melting methyl methacrylate resin was injected (the screw rotation was started) into the cavity made thereby. At that time, while keeping the extreme point of the screw at the most front position, the resin was injected into the mold under the screw rotation. The viscosity of the melting resin passing through the gate was obtained by the above-mentioned method.

When compressing the mold by an injection compression method such as the Rolinx process, the clamping force is set at from 100 to 150 tons prior to filling the resin, and the resin is filled into the mold under this condition, whereby the mold is gradually opened under the filling by a stronger resin pressure than the clamping force. The clamping force is set in advance so as to reach 450 tons when the mold opening clearance reaches 100 μm. And, when the mold opening clearance reaches 100 μm, the compression is carried out by re-clamping till zero-touch. The compression is carried out immediately prior to the complete filling. When compressing the mold by an injection pressing method, the mold is opened by about 100 μm from the zero-touch in advance prior to filling the resin, under which condition the resin is filled, and the mechanical clamping is started before or after completion of the filling, and the compression is carried out till zero-touch.

Next, when the resin has been filled in the cavity, the screw is moved gradually backward. When the screw is moved backward by 15 mm, a holding pressure is also added from the cylinder side, at which time the medium in the fluid passageway is exchanged to a coolant such that the surface temperature of the mold cavity is cooled to 85° C. at the completion of the holding pressure. After such a condition is maintained for a predetermined time, the holding pressure is released. When a value of the temperature sensor of the mold generated from the mold has reached 20° C., the valve stand is changed by a timer, whereby the heat transfer medium is passed through the fluid passageway. When the value of the temperature sensor of the mold generated from the mold shows about 45° C., the mold is opened, and a cooled molded article is taken out. Thereafter, the mold is closed again, and the surface temperature of the mold cavity is raised continuously. When the value of the temperature sensor of the mold generated from the mold shows 100° C., a signal for beginning the injection is automatically sent to the molding machine, and the next cycle starts.

The light transmitting plate so obtained had fixed dimension accuracy, an accurate copy of the rough pattern of the cavity surface, a superior appearance, and a small molding strain.

### Reference Example 1

In order to explain importance of the injection rate and melting resin viscosity at an inlet of a mold defined in the present invention, there is shown the following comparative example, wherein a light transmitting plate was produced by supplying a melting resin into a mold cavity at a slow rate without compression of the mold after injecting and filling.

This comparative example used a molding machine, NESTAL 200SYCAP, manufactured by Sumitomo Heavy Industries, Ltd., whose ROM was reconstructed so as to be able to flow a resin continuously into a mold under screw rotation in a cylinder. The mold was designed in such a size as to be able to mold by installing in the molding machine having a clamping force of 200 tons with a cavity of one molded article. A main body of the light transmitting plate had a shape similar to that shown in FIG. 6, and was designed so as to have a size of 31 cm×24 cm, and thickness of 6 mm.

On the fixed mold cavity side corresponding to the reflection layer side, there was applied a cavity plate for copying a pattern, which cavity plate had a surface made of a high thermal conductivity-carrying beryllium-copper alloy containing 0.5% by weight of beryllium and 1.6% by weight of nickel, and had on its surface a real circle-shaped dotted pattern in place of printing given in advance by an etching treatment. Respective dots in this dotted pattern were large in its center of the longitudinal direction, and became smaller together with increase of a distance from the center. In the center, said dot had a diameter of about 1.0 mm, and a pitch of about 1.5 mm among the dots. In the end part of the light source side, said dot had a diameter of about 0.6 mm, and a pitch of about 1.5 mm among the dots. On the surface of the movable mold cavity side made of the same beryllium-copper alloy as that mentioned above corresponding to the emitting side, nickel was plated, and further, there was installed the cavity plate mirror polished. In order to raise or lower mold temperature during a cycle, there was installed a fluid passageway having a diameter of 15 mm in both of the fixed mold and the movable mold, which fluid passageway was positioned inside about 9 mm distance away from the cavity plate side. A cooling-heating cycle was obtained by passing through the fluid passageway alternately cold water as a coolant having temperature of about 30° C. supplied from a cooling unit for a coolant, and pressurized water as a heat transfer medium having temperature of about 130° C. supplied from a temperature-regulation unit for a heat transfer medium. Here, the cavity surface temperature measured by a surface thermometer was set so as to be 125° C. under passing the heat transfer medium therethrough.

As the resin, a transparent methyl methacrylate resin, SMIPEX MG5, produced by Sumitomo Chemical Co., Ltd., was used, and temperature of the resin in an injection cylinder was set at 240° C. The fixed mold and the movable mold were closed, and the methyl methacrylate resin was injected into the cavity made by the both molds under screw rotation in the cylinder. When the resin was filled in the cavity, a holding pressure was added, at which time a medium in the fluid passageway was exchanged to a coolant, and then cooling was carried out such that surface temperature of the mold cavity was 85° C. at the time of completion of the holding pressure. After said condition was kept for 40 seconds, the holding pressure was released. Since surface temperature of the molded article reached 70° C. in about 70 seconds after the above-mentioned exchange to the coolant, the mold was opened through the cooling step, and the molded article was taken out. Thereafter, temperature was again raised such that surface temperature of the mold cavity was raised to 125° C., and the mold was closed to start the next cycle.

In the above-mentioned operation, molding was carried out under changing the injection rate by setting various screw rotation speeds in injecting the resin. Results are shown in Table 1, which was obtained by the steps of (i) measuring the filling time required from the beginning of the injection to the changing of the holding pressure, and weights of the molded articles, (ii) calculating injection rates based thereon, and further (iii) obtaining viscosities of the melting resin passing through the gate according to the above-mentioned method. Observing appearance of the obtained molded articles, it was judged whether or not sink marks (hollow parts due to volume shrinkage), short shots (parts not-filled by the resin), and flow marks (flow patterns on the surface) existed. Results thereof are also shown in Table 1, wherein the marks ◯ and X show “good” and “not good”, respectively.

TABLE 1

| | | | | | | |
|---|---|---|---|---|---|---|
| Resin temperature | 240 | 240 | 240 | 240 | 240 | 240 |
| (° C.) | | | | | | |
| Filling time(sec) | 130 | 102 | 83 | 60 | 41 | 30 |
| Wight(g) | 490 | 506 | 513 | 549 | 556 | 558 |
| Injection rate | 3.17 | 4.17 | 5.19 | 7.69 | 11.40 | 15.6 |
| (cm³/sec)* | | | | | | |
| Viscosity at inlet | 560 | 500 | 440 | 310 | 240 | 190 |
| (Pa · sec) | | | | | | |
| Observation of | | | | | | |
| appearance | | | | | | |
| Sink mark | ◯ | ◯ | ◯ | ◯ | ◯ | X |
| Short-shot | X | ◯ | ◯ | ◯ | ◯ | ◯ |
| Flow mark | X | ◯ | ◯ | ◯ | ◯ | ◯ |

^{*}The injection rate was obtained by a method comprising the steps of (i) converting weight to volume based on a specific gravity (1.19) of a methyl methacrylate resin, and (ii) dividing the volume (cm³) by the filling time (sec).

1. A process for producing a light transmitting plate comprising the steps of:
(1) connecting a cylinder of an injection unit with a cavity of a mold having a diagonal length of from 14 inches (355 mm) to 30 inches (760 mm), wherein (i) said mold is for making a light transmitting plate for a liquid crystal display, (ii) said mold comprises a fixed mold and a movable mold, and (iii) a cavity side of at least one mold of said fixed mold and said movable mold has a rough pattern on its surface,
(2) supplying a transparent resin to said cylinder, and melting said resin,
(3) filling said resin into said mold cavity from said cylinder at an injection rate of from 1 to 15 cm³/sec per one light transmitting plate, wherein said resin passing through an inlet of said mold has a viscosity of from 50 to 5000 Pa·sec,
(4) pressing additionally said resin present in said mold cavity from a side of said cavity during or after the above-mentioned filling, and
(5) cooling said resin under holding said pressure to solidify said resin, thereby obtaining a light transmitting plate having said rough pattern on its surface.

2. The process for producing a light transmitting plate according to claim 1, wherein the injection rate is from 4 to 11 cm³/sec.

3. The process for producing a light transmitting plate according to claim 1, wherein the mold cavity in the step (3) has surface temperature of from a glass transition temperature of a transparent resin −20° C. to the glass transition temperature +30° C. when the transparent resin passes through an inlet of the mold, and has surface temperature of from the glass transition temperature of the transparent resin +10° C. to the glass transition temperature +30° C. just when the transparent resin has been completely filled, and the mold cavity after the filling in the step (4) has surface temperature lower than the glass transition temperature of the transparent resin.

4. The process for producing a light transmitting plate according to claim 1, wherein the cavity has a fluid passageway in the vicinity of its side to pass a heat transfer medium and a coolant alternately.

5. The process for producing a light transmitting plate according to claim 1, wherein the cavity side has a cavity block in its vicinity comprising a metal having a larger thermal conductivity than a metal constituting a main body of a mold, and the cavity block has a fluid passageway in its inside to pass a heat transfer medium and a coolant alternately.

6. The process for producing a light transmitting plate according to claim 5, wherein the cavity block comprises a beryllium-copper alloy.

7. The process for producing a light transmitting plate according to claim 1, wherein at least one cavity side comprises a cavity plate.

8. The process for producing a light transmitting plate according to claim 1, wherein the additional pressure in the step (4) is given to a total side of a cavity.

9. The process for producing a light transmitting plate according to claim 1, wherein the transparent resin is a methacrylic resin.

10. A process for producing a light transmitting plate comprising the steps of:
(1) connecting a cylinder of an injection unit with a cavity of a mold having a diagonal length of from 14 inches (355 mm) to 30 inches (760 mm), wherein (i) said mold is for making a light transmitting plate for a liquid crystal display, (ii) said mold comprises a fixed mold and a movable mold, and (iii) a cavity side of at least one mold of said fixed mold and said movable mold has a rough pattern on its surface,
(2) supplying a transparent resin to said cylinder, and melting said resin,
(3) flowing continuously said resin into said mold cavity from said cylinder by rotation of a screw present in said cylinder,
(4) pressing additionally said resin present in said mold cavity from a side of said cavity during or after the above-mentioned flowing, and
(5) cooling said resin under holding said pressure to solidify said resin, thereby obtaining a light transmitting plate having said rough pattern on its surface.

11. The process for producing a light transmitting plate according to claim 10, wherein the mold cavity in the step (3) has surface temperature of from a glass transition temperature of a transparent resin −20° to the glass transition temperature +30° C. when the transparent resin passes through an inlet of the mold, and has surface temperature of from the glass transition temperature of the transparent resin +10° C. to the glass transition temperature +30° C. just when the transparent resin has been completely filled, and the mold cavity after the filling in the step (4) has surface temperature lower than the glass transition temperature of the transparent resin.

12. The process for producing a light transmitting plate according to claim 10, wherein the cavity has a fluid passageway in the vicinity of its side to pass a heat transfer medium and a coolant alternately.

13. The process for producing a light transmitting plate according to claim 10, wherein the cavity side has a cavity block in its vicinity comprising a metal having a larger thermal conductivity than a metal constituting a main body of a mold, and the cavity block has a fluid passageway in its inside to pass a heat transfer medium and a coolant alternately.

14. The process for producing a light transmitting plate according to claim 13, wherein the cavity block comprises a beryllium-copper alloy.

15. The process for producing a light transmitting plate according to claim 10, wherein at least one cavity side comprises a cavity plate.

16. The process for producing a light transmitting plate according to claim 10, wherein the additional pressure in the step (4) is given to a total side of a cavity.

17. The process for producing a light transmitting plate according to claim 10, wherein the transparent resin is a methacrylic resin.
